(19) United States
(12) Patent Application Publication
(10) Pub. No.: US 2015/0249835 A1
(43) Pub. Date: Sep. 3, 2015

(54) METHOD FOR ADAPTIVELY TRANSMITTING FEC PARITY DATA USING CROSS-LAYER OPTIMIZATION

(71) Applicant: HUMAX HOLDINGS CO., LTD., Yongin (KR)

(72) Inventors: Alex Chungku Yie, Incheon (KR); Yong-Jae Lee, Seoul (KR); Hui Kim, Namyangju (KR)

(21) Appl. No.: 14/427,620

(22) PCT Filed: Sep. 27, 2013
(86) PCT No.: PCT/KR2013/008666

§ 371 Date: Mar. 11, 2015

(30) Foreign Application Priority Data
Sep. 28, 2012 (KR) 10-2012-0108961
Sep. 27, 2013 (KR) 10-2013-0114951

(51) Int. Cl. H04N 19/166; H04L 1/00; G06F 11/07; H04N 19/89

(52) U.S. Cl. CPC H04N 19/166; H04N 19/89; H04L 1/0041; G06F 11/076

(57) ABSTRACT

Provided is a method for transmitting multi-media in a heterogeneous network transmission environment or a hybrid transmission environment of broadcasting and broadband IP networks, in which information for PHY channel state information is transmitted so that same is comprised in the header of a forward error correction (FEC) parity unit, and on the basis of the channel state information, when the channel state is good, the amount of parity data is reduced so as to raise the data transmission rate, and when the channel state is poor, the amount of parity data is increased so that data errors are corrected at a high rate, thus reducing the number of data re-transmissions, and thereby raising the data transmission rate.

### BACKGROUND OF THE INVENTION

1. Field of the invention

The present invention relates to a method for transmitting FEC parity data, and more particularly, to a method for adaptively transmitting FEC parity data according to a channel state.

2. Related Art

After standardization of MPEG-2, as a video compression standard (alternatively, an audio compression standard), new standards such as MPEG-4, H.264/AVC, scalable video coding (SVC), and the like have been consistently developed for past 10 years and further, the new respective standards have widened a utilization area of an MPEG standard while forming a new market, but a transmission technique such as an MPEG-2 transport system (TS) has been widely used in digital broadcasting, mobile broadcasting (T-DMB, DVB-H, and the like), and the like in a market invariably during the passing of almost 20 years and still widely used even in multimedia transmission through the Internet, that is, an IPTV service which was not considered at the time when the standard is established.

However, a present-day multimedia transmission environment has been significantly changed from a multimedia transmission environment when the MPEG-2 TS is developed. For example, the MPEG-2 TS standard has been developed by considering that multimedia data is transmitted through an ATM network at the time of establishing the MPEG-2 TS standard, but it has become almost difficult to find an example used for the purpose theses days. Further, since a requirement such as multimedia transmission using the Internet is not considered at the time of establishing the MPEG-2 TS standard, elements which are not efficient in the multimedia transmission through the Internet have existed in recent years. Therefore, a new multimedia transmission technique considering a multimedia service in the Internet suitable for a changed multimedia environment is required.

As described above, a primary reason for requiring the new multimedia transmission technique is that since the MPEG-2 TS standard which was made 20 years ago has been optimized to an IPTV broadcasting service, an Internet environment, and the like in recent years, a multimedia transmission technique optimized to the multimedia transmission environment in various heterogeneous networks has been immediately required in recent years.

That is, in recent years, packets transmitted in various heterogeneous networks may be significantly different in packet error rate received according to a transmission channel state and in this case, it was difficult to provide optimal FEC processing reflected with the channel state in the related art.

Further, in the case of hybrid delivery in which AV streaming is transmitted through a broadcasting network and additional information is transmitted through a broadband network, packets transmitted through different networks may also be significantly different in packet error rate received according to the transmission channel state and in this case, the optimal FEC processing reflected with the channel state could not be provided in the related art.

### SUMMARY OF THE INVENTION

The present invention provides a method for transmitting multimedia through adaptively controlling an FEC parity using cross-layer optimization under a transmission environment in heterogeneous networks or a hybrid transmission delivery environment of a broadcasting network and a broadband IP network.

Provided is a method in which the existing PHY channel state information is delivered with channel state information being included in a header of a parity unit of FEC and any parity data set among parity data sets having different sizes is adaptively selected and transmitted according to a channel state.

In an aspect, a method for transmitting multimedia through adaptively controlling an FEC parity using cross-layer optimization includes deciding the size of an FEC parity data set by using channel state information received from a lower layer.

The deciding of the size of the FEC parity data set by using the channel state information received from the lower layer may include receiving channel state information by using a cross-layer interface performing data transmission between an application layer and a lower layer including an MAC or PHY layer.

The channel state information may be generated in the PHY or MAC layer.

The deciding of the size of the FEC parity data set by using the channel state information received from the lower layer may include receiving the channel state information from the lower layer, estimating a channel state by using the channel state information, and deciding the size of the FEC parity data set by using the estimated channel state.

The channel state information may be bit error rate (BER) information.

In the deciding of the size of the FEC parity data set by using the channel state information received from the lower layer, the size of the FEC parity data set included in the channel state information may be used as the size of the FEC parity data set.

The method may further include generating parity data by using the decided size of the parity data set.

The generating of the parity data by using the decided size of the parity data set may include generating parity data by including a field indicating the size of the parity data in a header of the parity data.

The field indicating the size of the parity data may indicate the size of the parity data by designating any one of sets of a predetermined size.

The multimedia transmitting method may support hybrid transmission.

In another aspect, a method for transmitting multimedia through adaptively controlling an FEC parity using cross-layer optimization, as a method using layer structure with a lower layer, a transport layer operating on the lower layer, and an MPEG media transport (MMT) layer, includes deciding the size of an FEC parity data set by using channel state information received from the lower layer.

The deciding of the size of the FEC parity data set by using the channel state information received from the lower layer may include receiving channel state information by using a cross-layer interface performing data transmission between an application layer and a lower layer including an MAC or PHY layer.

The deciding of the size of the FEC parity data set by using the channel state information received from the lower layer may include receiving bit error rate (BER) information from the lower layer, estimating a channel state by using the bit error rate (BER) information, and deciding the size of the FEC parity data set by using the estimated channel state.

In the deciding of the size of the FEC parity data set by using the channel state information received from the lower layer, the size of the FEC parity data set included in the channel state information may be used as the size of the FEC parity data set.

The method may further include generating parity data by using the decided size of the parity data set.

The generating of the parity data by using the decided size of the parity data set may include generating parity data by including a field indicating the size of the parity data in a header of the parity data.

The field indicating the size of the parity data may indicate the size of the parity data by designating any one of sets of a predetermined size.

The multimedia transmitting method may support hybrid transmission.

In yet another aspect, an apparatus for transmitting multimedia through adaptively controlling an FEC parity decides the size of an FEC parity data set by using channel state information received from a lower layer.

When a channel state is not good under a transmission environment in heterogeneous networks or a hybrid transmission delivery environment of a broadcasting network and a broadband IP network, more parity data for FEC are transmitted and when the channel state is good, less parity data for the FEC are transmitted to increase a data transmission rate.

### BRIEF DESCRIPTION OF THE DRAWINGS

FIG. 1 is a conceptual diagram illustrating an MPEG media transport (MMT) layer structure.

FIG. 2 is a conceptual diagram illustrating a format of unit information (alternatively, data or a packet) used for each layer of the MMT layer structure.

FIG. 3 is a conceptual diagram of an MMT package configuration.

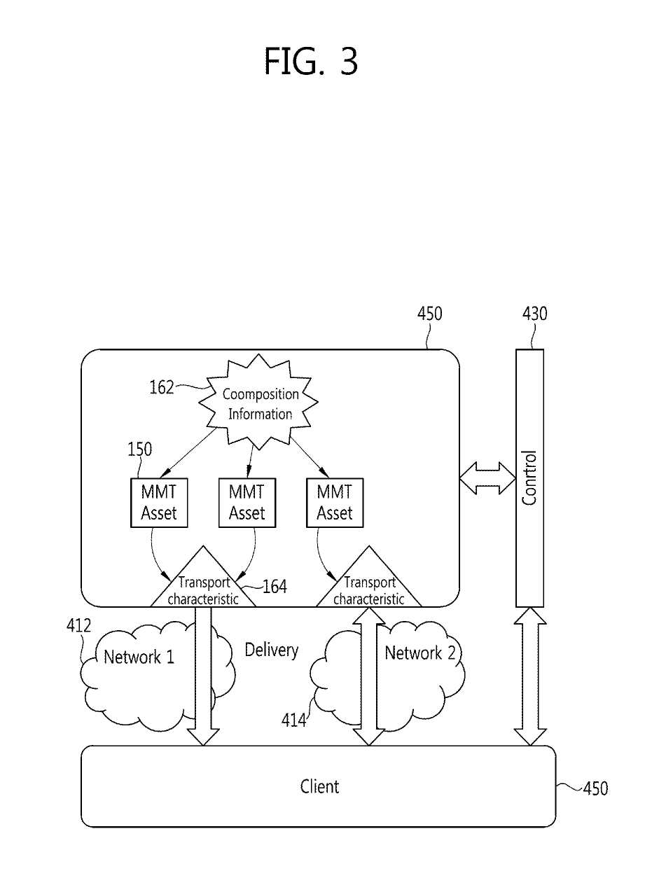

FIG. 4 is a conceptual diagram illustrating a method for providing channel state information to an FEC processing unit as cross-layer information (CLI) in a cross-layer interface according to an exemplary embodiment of the present invention.

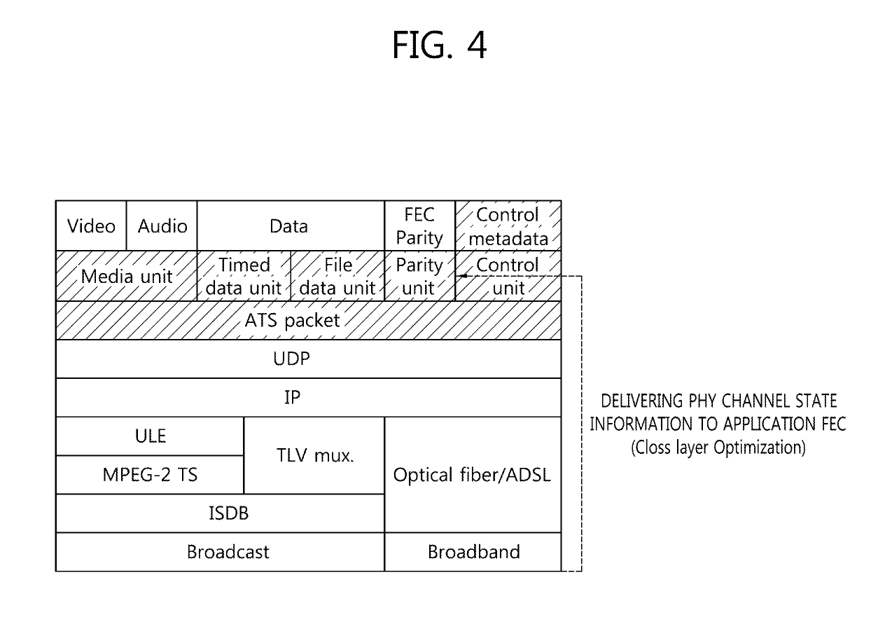

### DESCRIPTION OF EXEMPLARY EMBODIMENTS

The present invention may have various modifications and various exemplary embodiments and specific exemplary embodiments will be illustrated in the drawings and described in detail.

However, this is not intended to limit the present invention to the specific exemplary embodiments, and it should be understood that the present invention covers all the modifications, equivalents and replacements included in the spirit and technical scope of the present invention.

Terms such as first or second may be used to describe various components but the components are not limited by the above terminologies. The above terms are used only to discriminate one component from another component. For example, without departing from the scope of the present invention, a first component may be referred to as a second component, and similarly, the second component may also be referred to as the first component. A term “and/or” includes a combination of a plurality of associated disclosed items or any item of the plurality of associated disclosed items.

It should be understood that, when it is described that an element is “coupled” or “connected” to another element, the element may be “directly coupled” or “directly connected” to the other element or “coupled” or “connected” to the other element through a third element. In contrast, it should be understood that, when it is described that an element is “directly coupled” or “directly connected” to another element, it is understood that there are no intervening elements.

Terms used in the present application are used only to describe specific exemplary embodiments, and are not intended to limit the present invention. Singular expressions used herein include plurals expressions unless they have definitely opposite meanings in the context. In the present application, it should be understood that term “include” or “have” indicates that a feature, a number, a step, an operation, a component, a part or the combination thereof described in the specification is present, but does not exclude a possibility of presence or addition of one or more other features, numbers, steps, operations, components, parts or combinations, in advance.

If it is not contrarily defined, all terms used herein including technological or scientific terms have the same meanings as those generally understood by a person with ordinary skill in the art. It should be understood that terms defined in a generally used dictionary have the same meanings as contextual meanings of associated techniques and if not apparently defined in this application, the terms are not ideally or excessively understood as formal meanings.

Hereinafter, meanings of terms will be described below.

Non-timed data defines all data elements consumed without specifying a time. The non-timed data may have a time range in which data may be executed or started.

Time data defines a data element associated with a specific time which is decoded and presented.

A service is defined as one or one or more content components transmitted for presentation or storage.

Service information is defined as metadata that describe one service, and characteristics and components of the service.

An access unit (AU) as a smallest data entity may have timing information as an attribute. When encoded media data in which the timing information is not designated for the decoding and the presentation is associated, the AU is not defined.

A media fragment unit (MFU) as a general container independent even from any specific codec accommodates encoded media data which may be independently consumed by a media decoder. This accommodates information which may be used in a delivery layer with a size equal to or smaller than the access unit (AU).

A media processing unit as a general container independent even from any specific media codec accommodates information associated with at least one AU and additional transmission and consumption. For the non-timed data, the MPU accommodates the part of data which does not belong to an AU range. The MPU is encoded media data which may be completely and independently processed. Processing in the context means encapsulation or packetization into an MMT package for transmission.

An MMT asset is a logic data object constituted by at least one MPU together with the same MMT asset ID or a specific data lump together with a format defined in another standard. The MMT asset is a largest data unit to which the same composition information and transport characteristics are applied.

MMT asset delivery characteristics (MMT-ADC) are a description associated with a QoS request for transmitting the MMT asset. The MMT-ADC is expressed so as not to know a specific transmission environment.

MMT composition information (MMT CI) represents spatial and temporal relationships among the MMT assets.

The MMT package as a collection of logically structured data is constituted by at least one MMT asset, the MMT composition information, the MMT asset transport characteristics, and explanatory information.

An MMT packet is a format of data generated or consumed by an MMT protocol.

An MMT payload format is a format for a payload of the MMT package or an MMT signaling message to be delivered by the MMT protocol or an Internet application protocol (e.g., RTP).

A content component or a media component is defined as media of a single type or a subset of the media of the single type and may be, for example, a video track, movie subtitles, or an enhancement layer of video.

Contents are defined as a set of content components and may be, for example, a movie, a song, and the like.

Hybrid delivery is defined as an operation in which one or one or more content components are simultaneously transmitted through one or more physically different types of networks.

Hereinafter, a preferable embodiment of the present invention will be described in more detail with reference to the accompanying drawings. In describing the present invention, like reference numerals refer to like elements for easy overall understanding and a duplicated description of like elements will be omitted.

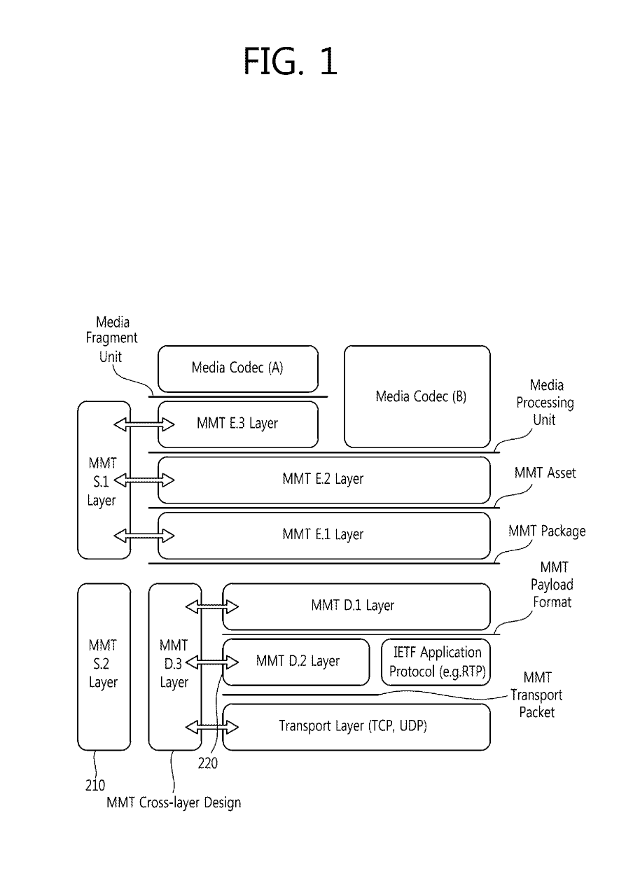

FIG. 1 is a conceptual diagram illustrating an MPEG media transport (MMT) layer structure.

Referring to FIG. 1, the MMT layer structure includes a functional area having an encapsulation layer, a delivery layer and a signaling layer. The MMT layer operates on a transport layer.

The encapsulation layer (E-layer) defines a logical structure of formats of media contents, an MMT package and data units to be processed by an entity that observes MMT. In order to provide information required for adaptive transmission, the MMT package specifies components including the media contents and a relationship thereamong. The formats of the data units are defined to be stored in or transmitted as a payload of a transmission protocol and encapsulate media encoded to be easily converted thereamong.

The encapsulation layer (E-layer) may take care of functions including, for example, packetization, fragmentation, synchronization, multiplexing, and the like of transmitted media.

The encapsulation layer (E-layer) may be consisted of an MMT E.1 layer, an MMT E.2 layer, and an MMT E.3 layer as illustrated in FIG. 1.

The E.3 layer encapsulates a media fragment unit (MFU) provided from a media codec (A) layer to generate a media processing unit (MPU).

Encoded media data from a higher layer are encapsulated by the MFU. Types and values of the encoded media are abstracted so as to generally use the MFU in a specific codec technique. This allows a lower layer to process the MFU without accessing the encapsulated encoded media and the lower layer calls the required encoded media data from a network or a buffer of storage and transmits the required encoded media data to a media decoder. The MFU has an information media part unit which is sufficient to perform the operation.

The MFU may have a format which may be independent from arbitrary specific codec and load a data unit which may be independently consumed in the media decoder. The MFU may be, for example, a picture or a slice of a video.

One MFU or a plurality of MFUs of one group which may be independently transmitted and decoded generates the MPU. Non-timed media which may be independently transmitted and executed also generate the MPU. The MPU describes an internal structure of an array and a pattern of the MFU to enable rapid access to the MFU and partial consumption.

The E.2 layer encapsulates the MPU generated in the E.3 layer to generate an MMT asset.

A sequence of the MPU from the same source component generates the MMT asset. The MMT asset is packaged by the MMT package and is constituted with different things by composition information (CI) and transport characteristics (TC), multiplexed with different things by an MMT payload format, and transmitted by an MMT protocol.

The MMT asset, as a data entity constituted one or a plurality of MPUs from a single data source, is a data unit in which the composition information (CI) and the transport characteristics (TC) are defined. The MMT asset may correspond to packetized elementary streams (PES) and correspond to, for example, the video, audio, program information, an MPEG-U widget, a JPEG image, an MPEG 4 file format, an MPEG transport stream (M2TS), and the like.

The E.1 layer encapsulates the MMT asset generated in the E.2 layer to generate the MMT package.

The MMT asset is packaged with MMT composition information (MMT-CI) for a further response of the same user experience together with or separately from a functional area-transport area and a signal area which are different. The MMT package is also packaged together with transport characteristics to select an appropriate transmission method for respective MMT assets so as to the quality of experience of the MMT asset.

The MMT package may be constituted by one or a plurality of MMT assets together with the additional information such as the composition information (CI) and the transport characteristics (TC). The MMT package may correspond to a program of the MPEG-2 TS.

The composition information includes information on the relationship among the MMT assets and when one content is constituted by a plurality of MMT packages, the composition information may further include information for representing the relationship among the plurality of MMT packages.

The transport characteristics may include transport characteristic information required to decide a delivery condition of the MMT asset or the MMT packet and may include, for example, a traffic description parameter and a QoS descriptor.

The delivery layer (D-layer) defines an application layer protocol and a format of a payload. The payload format is defined to deliver the encoded media data irrespective of a media type or an encoding method.

The delivery layer (D-layer) may perform, for example, network flow multiplexing, network packetization, QoS control and the like of the media transmitted through the network.

The delivery layer (D-layer) may be consisted of an MMT D.1 layer, an MMT D.2 layer, and an MMT D.3 layer as illustrated in FIG. 1.

The D.1 layer receives the MMT package generated in the E.1 layer to generate an MMT payload format. The MMT payload format is a payload format for transmitting the MMAT asset and transmitting information consumption by the existing other application transmission protocols such as an MMT application protocol or an RTP. An MMT payload may include a fragment of the MFU together with information such as AL-FEC.

The D.2 layer receives the MMT payload format generated in the D.1 layer to generate an MMT transport packet or an MMT packet. The MMT transport packet or the MMT packet is a data format used in the application transmission protocol for the MMT.

The D.3 layer provides a function to exchange information between layers by a cross-layer design to support a QoS. For example, the D.3 layer may perform the QoS control by using a QoS parameter of an MAC/PHY layer.

The signaling layer (S layer) performs a signaling function. For example, the signaling layer may perform the signaling function for session initialization, control, and management, a server based and/or client based trick mode, service discovery, synchronization, and the like of the media.

The signaling layer defines a format of a message for delivering and consuming the MMT package. The message for the consumption management is used to transmit a structure of the MMT package and the message for the delivery management is used to transmit a structure of the payload format and a configuration of the protocol.

The signaling layer (S layer) may be consisted of an MMT S.1 layer and an MMT S.2 layer as illustrated in FIG. 1.

The S.1 layer may perform service discovery, media session initialization and termination, media session presentation and control, an interface function with the delivery (D) layer and the encapsulation (E) layer, and the like. The S.1 layer may define formats of control messages among applications for media presentation session management.

The S.2 layer may define formats of control messages exchanged among delivery end points of the delivery layer (D layer), which are associated with flow control, delivery session management, delivery session monitoring, and error control, hybrid network synchronization control.

The S.2 layer may include delivery session establishment and release, delivery session monitoring, flow control, error control, resource reservation for an established delivery session, signaling for synchronization under a hybrid delivery environment, and signaling for adaptive delivery. The S.2 layer may provide signaling required between a sender and a receiver. That is, the S.2 layer may provide the signaling required between the sender and the receiver in order to support the operations of the delivery layers described above. Further, the S.2 layer may take charge of the interface function with the delivery layer and the encapsulation layer.

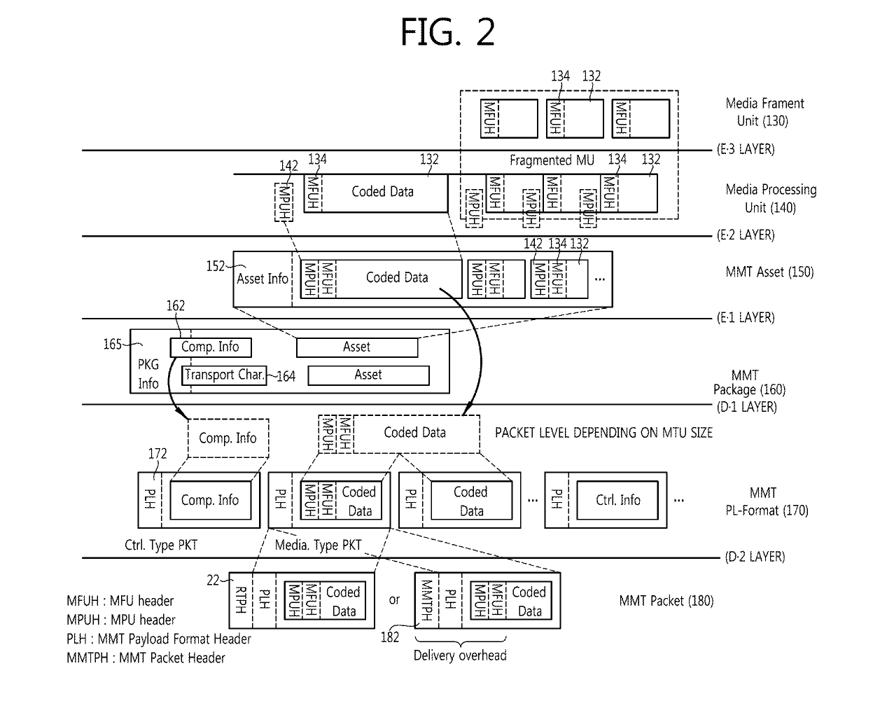

FIG. 2 is a conceptual diagram illustrating a format of unit information (alternatively, data or a packet) used for each layer of the MMT layer structure.

A media fragment unit (MFU) defines a format of encapsulating a part of the AU in a transport layer in order to perform adaptive transport in a range of the MFU. The MFU may be used to transport a predetermined format of a media which is coded so that the part of the AU may be independently decoded or discarded.

The MFU 130 is configured by coded media fragment data 132 and a media fragment unit header (MFUH) 134. The MFU 130 has a general container format independently from a specific codec and carries a smallest data unit which may be independently consumed in the media decoder. The MFUH 134 may include additional information such as a media attribute-for example, loss tolerance. The MFU 130 may be, for example, a picture or a slice of a video.

The MFU has an identifier for identifying one MFU from other MFUs and has general relation information between the MFUs in a single AU. A dependency relation between the MFUs in the single AU is described, and a related priority of the MFU is described as a part of the information. The information may be used to handle transport in a lower transport layer. For example, the transport layer may omit transport of the MFUs to be discarded so as to support QoS transport in an insufficient bandwidth.

The MPU is a set of MFU including a plurality of MFUs 130. The MPU has a general container format independently from the specific codec and includes media data equivalent to an access unit. The MPU may have a timed data unit or a non-timed data unit.

The MPU is data which are independently and completely processed by an entity following the MMT, and the processing includes encapsulation and packetizing. The MPU may have a part of data having a format which is configured by at least one MFU or defined by a different standard.

The single MPU may accept an integral number of at least one AU or non-timed data. For the timed data, the AU may be transferred from at least one MFU, but one AU may not be segmented into a plurality of MPUs. In the non-timed data, one MPU accepts a part of the non-timed data which are independently and completely processed by the entity following the MMT.

The MPU may be uniquely identified in a MMT package as a sequence number or an associated asset ID which identifies the sequence number from other MPUs.

The MPU has at least one random access point. A first byte of a MPU payload may always start from the random access point. In the timed data, the fact means that in the MPU payload, a decoding order of the first MPU is always 0. In the timed data, a presentation period and a decoding order of each AU may be transported in order to inform a presentation time. The MPU does not have an initial presentation time of the MPU, and the presentation time of the first AU of one MPU may be described in composition information. The composition information may specify a first presentation time of the MPU.

An MMT asset 150 is a set of MPU configured by the plurality of MPUs. The MMT asset 150 is a data entity configured by the plurality of MPUs (timed or non-timed data) from a single data source, and MMT asset information 152 may include additional information such as asset packaging metadata and a data type. The MMT asset 150 may include, for example, a video, an audio, program information, a MPEG-U widget, a JEPG image, a MPEG 4 file format (FF), packetized elementary streams (PES), a MPEG transport stream (M2TS), and the like.

Further, the MMT asset may be a logical data entity having the coded media data. The MMT asset has the MMT asset header and the coded media data. The coded media data may be a group of MPUs which are collectively referred to as the same MMT asset ID. Data of a type which is consumed as an entity directly related with an MMT client may be a divided MMT asset. An example of the data types may include a MPEG-2 TS, a PES, an MP4 file, a MPEG-U Widget Package, a JPEG file.

The coded media of the MMT asset may be timed data or non-timed data. The timed data are audiovisual media data requiring synchronized decoding and presentation of specific data at a predetermined time. The non-timed data are data of a data type which may be decoded and provided at any time depending on provision of the service or user interaction.

A service provider may integrate MMT assets to generate a multimedia service MMT with the MMT assets on a spatial-temporal axis.

An MMT package 160 is a set of MMT assets including one MMT asset or one or more MMT assets 150. The MMT assets in the MMT package may be multiplexed or concatenated.

The MMT package is a container format for the MMT asset and configuration information. The MMT package provides a storage of the MMT asset and the configuration information for the MMT program.

The MMT program provider encapsulates the coded data to the MMT asset and generates the MMT asset and the configuration information which describes a temporal and spatial layout of the transport characteristics of the MMT assets. The MU and the MMT asset may be directly transported by a D.1 payload format. The configuration information may be transported by a C.1 presentation section management message. However, the MMT program provider and the client which permit relay of the MMT program and later reusing store the configuration information by a MMT package format.

When the MMT package is parsed, the MMT program provider determines whether the MMT asset is provided to the client by using any transport path (for example, broadcast or broadband). The configuration information in the MMT package is transported to a S.1 presentation section management message in addition to the transport-related information.

The client receives the S.1 presentation section management message to know which MMT program is possible and how the MMT asset for the corresponding MMT program is received.

The MMT package may also be transported by the D.1 payload format. The MMT package is packetized and transferred by the D.1 payload format. The client receives the packetized MMT package, configures all or a part of the packetized MMT package, and here, consumes the MMT program.

Package information 165 of the MMT package 160 may include configuration Information. The configuration Information may include additional information such as a list of MMT assets, package identification information, composition information 162, and transport characteristics 164. The composition information 162 includes information on a relation between the MMT assets 150.

Further, the composition information 162 may further include information for representing a relation between a plurality of MMT packages in the case where one content is configured by the plurality of MMT packages. The composition information 162 may include information on temporal, spatial, and adaptive relations within the MMT package.

Like the information assisting the transport of the MMT package and the presentation, the composition Information in the MMT provides information on a spatial and temporal relation between the MMT assets within the MMT package.

MMT-CI is a descriptive language which provides the information by extending HTML5. When the HTML5 is designed so as to describe a page-based presentation of a text-based content, the MMT-CI mainly expresses a spatial relation between the sources. In order to support the expression which notifies the temporal relation between the MMT assets, like a presentation resource, information related to the MMT asset in the MMT package, time information determining the transport of the MMT asset and a consumption order, and various MMT assets in the HTML5 may be extended so as to have additional attributes of media elements.

The transport characteristics information 164 includes information on the transport characteristics, and may provide information required for determining a delivery condition of each MMT asset (alternatively, an MMT packet). The transport characteristics information may include a traffic description parameter and a QoS descriptor.

The traffic description parameter may include bitrate information, priority information, and the like on the MFU 130 or the MPU. The bitrate information may include, for example, information whether the MMT asset is a variable bitrate (VBR) or a constant bitrate (CBR), a guaranteed bitrate for the MFU (alternatively, the MPU), and a maximum bitrate for the MFU (alternatively, the MPU). The traffic description parameter may be used for resource reservation among a server, a client, and other constituent elements on the transport path, and for example, may include maximum size information of the MFU (alternatively, the MPU) within the MMT asset. The traffic description parameter may be periodically or aperiodically updated.

The QoS descriptor includes information for QoS control, and for example, may include delay information and loss information. The loss information may include, for example, a loss indicator for whether the delivery loss of the MMT asset is permitted or not. For example, when the loss indicator is ‘1’, ‘lossless’ may be represented, and when the loss indicator is ‘0’, ‘lossy’ may be represented. The delay information may include a delay indicator used to identify sensitivity of the transport delay of the MMT asset. The delay indicator may indicate whether a type of MMT asset is conversation, interactive, real time, and non-real time.

One content may be configured by one MMT package. Alternatively, one content may also be configured by a plurality of MMT packages.

When one content may also be configured by the plurality of MMT packages, composition information or configuration information which represents the temporal, spatial, and adaptive relation among the plurality of MMT packages may exist in one MMT package among the MMT packages or exist outside the MMT package.

For example, in the case of a hybrid delivery, some of content components are transported through a broadcast network, and others of the content components may be transported through a broadband network. For example, in the case of a plurality of audiovisual (AV) streams configuring one multiview service, one stream is transported by the broadcast network, other streams may be transported by the broadband network, and each of the AV streams may be multiplexed and individually received and stored in the client terminal.

In the case of the multiview service scenarios, all of the plurality of AV streams may become one MMT package, and in this case, one of the plurality of streams may be stored only in one client terminal, a storage content is a part of the MMT package, the client terminal needs to re-record the composition information or the configuration information, and the recorded content becomes a server-independent new MMT package.

In the case of the multiview service scenarios, each of the AV streams may become one MMT package, and in this case, the plurality of MMT packages configures one content and is recorded by an MMT package unit in the storage, and the composition information or the configuration information representing the relation among the MMT packages is required.

The composition information or the configuration information included in one MMT package may be referred to as the MMT asset within another MMT package, and further, in an out-band situation, the composition information or the configuration information may express the outside of the MMT package referring to the MMT package.

Meanwhile, in order to notify an available path for transport of the list of the MMT assets 160 provided by the service provider and the MMT package 160 to the client terminal, the MMT package 160 is translated to service discovery information through a signaling (S) layer and the MMT control message may include an information table for service discovery.

The server which divides the multimedia contents into a plurality of segments allocates URL information to the plurality of segments divided into a predetermined number and stores the URL information for each of the segments in a media information file to transport the URL information to the client.

The media information file may be referred to as various names such as ‘media presentation description (MPD)’ or a ‘manifest file’ according to a standard organization which standardizes HTTP streaming Hereinafter, the medial information file is referred to as the MPD and will be described.

Hereinafter, a cross layer interface will be described.

The cross layer interface exchanges QoS-related information between an application layer and a lower layer including a MAC/PHY layer to provide a means supporting QoS to a single entity. The lower layer provides bottom-up QoS information like a network channel state, and the application layer provides information related to media characteristics as top-down QoS information.

The cross layer interface provides an integrated interface between the application layer and various network layers including IEE802.11 WiFi, IEEE 802.16 WiMAX, 3G, 4G LTE, and the like. Common network parameters of a mainly used network standard are extracted as network abstraction for media information (NAM) parameters for static and dynamic QoS control of a real-time media application through various networks. The NAM parameter may include a BER value which is a bit error rate. The BER may be measured in the PHY or MAC layer. Further, the NAM includes identification of a lower network, an available bitrate, a buffer state, a peak bitrate, a service unit size, and a service data unit loss rate to provide information on the state of the network channel. Alternatively, in the lower layer other than the application layer, the good degree of the channel state is estimated and thus a size to have a FEC parity set to be used in the FEC processor may be estimated based on the estimated channel state. A standard for determining whether the channel state is a good state may apply a standard for determining the generally used channel state.

Two different methods may be used to provide the NAM. A first method is to provide an absolute value. In addition, a second method is to provide a relative value. The second method may be used for updating the NAM during access.

The lower layer provides bottom-up QoS information in the application layer. The lower layer provides information related to a network state which is changed with time which enables QoS control which is faster and more accurate than the application layer. The bottom-up information is expressed in an abstracted form in order to support a heterogeneous network environment. The parameters are measured in the lower layer and read in the application layer periodically or according to a request of the MMT application.

The application layer provides the top-down QoS information related to the media characteristic for the lower layer. Two top-down information such as MMT asset level information and packet level information exist. The MMT asset information is used for capacity exchange and/or resource (re)allocation in the lower layer. Packet level top-down information is a proper field of all packets for the lower layer in order to identify the supporting QoS level.

Regarding the forward error correction (FEC), the transmitting side additionally transports parity data for error correction when the data is transported and the receiving side receives the parity data to detect error generation and correct the detected error.

The FEC parity data other than the data transported for the FEC is required. However, by selectively controlling the size of the parity data according to the channel state rather than transporting the FEC parity data regardless of the channel state, when the channel state is good, a quantity of the parity data is reduced to increase the transport rate of the data, and when the channel state is bad, the quantity of the parity data is increased to correct an error of the data at a high rate, thereby reducing the re-transport number of data and increasing the transport rate of the data.

According to the exemplary embodiment of the present invention, the size that the FEC parity set used in the FEC processor should have may be determined in the lower layer other than the application layer by estimating the channel state representing the good degree of the channel state in the lower layer other than the application layer. The size of the determined FEC parity set may be transferred to the application layer through cross layer information (CLI) by using a FEC_parity_size parameter of the NAM parameter. The FEC processor may determine the length of the FEC parity data set to be used by using the FEC_parity_size parameter of the NAM parameter.

The following Table 1 illustrates a network parameter including the NAM parameter.

TABLE 1

| Parameters | Description |
|---|---|
| CLI_id | The CLI_id is arbitrary integer number to identify this NAM |
| | among the underlying network. It could be Indicated whether |
| | BER is obtained from Physical or MAC layer. |
| available_bitrate | The available_bitrate is bitrate that the scheduler of the |
| | underlying network can guarantee to the MMT stream. The |
| | available_bitrate is expressed in kilobits per second. |
| | Overhead for the protocols of the underlying network is not |
| | included. |
| buffer_fullness | The buffer_fullness is remaining buffer size that the |
| | underlying network can allow to the MMT stream within the |
| | total buffer space. The buffer is used to absorb excess bitrate |
| | higher than the available_bitrate. The buffer_fullness is |
| | expressed in bytes. |
| peak_bitrate | The peak_bitrate is maximum allowable bitrate that the |
| | underlying network can assign to the MMT stream. The |
| | peak_bitrate is expressed in kilobits per second. Overhead for |
| | the protocols of the underlying network is not included. |
| current_delay | The current_delay parameter indicates the last hop transport |
| | delay. The current_delay expressed in milliseconds. |
| SDU_size | SDU (Service Data Unit) is data unit in which the underlying |
| | network delivers the MMT data. The SDU_size specifies the |
| | length of the SDU and is expressed in bits. Overhead for the |
| | protocols of the underlying network is not included. |
| SDU_loss_rate | The SDU_loss_ratio is fraction of SDUs lost or detected as |
| | errorneous. Loss ratio of MMT packets can be calculated as a |
| | function of SDU_loss_ratio and SDU_size. The |
| | SDU_loss_ratio is expressed in percentile. |
| generation_time | The time when the parameters are generated. The |
| | generation_time is expressed in milliseconds. |
| relative_bitrate | The available_bitrate change ratio (%) between the current |
| | NAM and the previous NAM information. |
| relative_buffert_fullness | The remaining buffer_fullness change ratio (%) between the |
| | current NAM and the previous NAM information. |
| relative_peak_bitrate | The peak_bitrate change ratio (%) between the current NAM |
| | and the previous NAM information. |
| BER | Bit Error Rate obtained from PHY or MAC layer. |
| FEC_parity_size(OPTION) | The FEC_parity_size parameter represents the length of an |
| | FEC parity data set in which the size is variably used |
| | according to the channel state. The FEC_parity_size |
| | parameter may be selectively used. |

According to another exemplary embodiment of the present invention, the channel state information such as BER and information of the service data unit loss rates may be delivered to the application layer through the Cross Layer Information (CLI) by using the aforementioned NAM parameter. The FEC processor may estimate a channel state after obtaining the channel state information by using the NAM parameter. The FEC processor determines the length of the FEC parity data set required according to the channel state. In another exemplary embodiment of the present invention, the FEC processor may use the FEC_parity_size parameter in order to represent the length of the FEC parity data set. The representing of the length of the required FEC parity data set may include representing the number of FEC parity payloads in a related FEC parity block.

Alternatively, as described above, according to the exemplary embodiment of the present invention, the lower layer other than the application layer estimates the channel state information and determines the size to have the FEC parity data set according to the estimated channel state to transport the determined size to the FEC processor of the application layer. The size to have the FEC parity data set estimated by the lower layer other than the application layer may be transferred to the application layer through the CLI by using the FEC_parity_size parameter of the aforementioned NAM parameter. That is, according to the exemplary embodiment of the present invention, the FEC processor may determine the length of the FEC parity data set to be used by using the FEC_parity_size parameter of the NAM parameter.

The FEC parity data set may be generated based on the length of the FEC parity data set determined by the FEC processor. The parity data set includes a header unit and a data unit, and the header unit may include the length of the parity data set. In the exemplary embodiment of the present invention, the header unit of the parity data set may accommodate a FEC_parity_size indicator in order to store the length of the FEC parity data set. The data unit may accommodate the parity data having a required length according to the channel state.

The receiving-side decoder receives the FEC parity data along with the data, and the receiving-side FEC processor identifies the length of the parity data set in the header of the FEC parity data set by using the FEC_parity_size and performs the FEC by using the parity data according to the length of the parity data set.

In another exemplary embodiment of the present invention, the length of the parity data set may be pre-determined with different sizes of the predetermined number. Accordingly, in order to represent the length of the required FEC parity data set by the FEC processor, the FEC_parity_size indicator may not directly represent the length of the parity data set, but may indirectly represent the length of the parity data set by a form of selecting one of standards of the parity data set having the predetermined length.

What is claimed is:

1. A method for transmitting multimedia through adaptively controlling an FEC parity using cross-layer optimization, the method comprising:
deciding the size of an FEC parity data set by using channel state information received from a lower layer.

2. The method of claim 1, wherein the deciding of the size of the FEC parity data set by using the channel state information received from the lower layer includes receiving channel state information by using a cross-layer interface performing data transmission between an application layer and a lower layer including an MAC or PHY layer.

3. The method of claim 1, wherein the channel state information is generated in the PHY or MAC layer.

4. The method of claim 1, wherein:
the deciding of the size of the FEC parity data set by using the channel state information received from the lower layer includes
receiving the channel state information from the lower layer,
estimating a channel state by using the channel state information, and
deciding the size of the FEC parity data set according to the estimated channel state.

5. The method of claim 4, wherein the channel state information is bit error rate (BER) information.

6. The method of claim 1, wherein in the deciding of the size of the FEC parity data set by using the channel state information received from the lower layer, the size of the FEC parity data set included in the channel state information is used as the size of the FEC parity data set.

7. The method of claim 1, further comprising:
generating parity data by using the decided size of the parity data set.

8. The method of claim 7, wherein the generating of the parity data by using the decided size of the parity data set includes generating parity data by including a field indicating the size of the parity data in a header of the parity data.

9. The method of claim 8, wherein the field indicating the size of the parity data indicates the size of the parity data by designating any one of sets of a predetermined size.

10. The method of claim 1, wherein the multimedia transmitting method supports hybrid transmission.

11. A method for transmitting multimedia through adaptively controlling an FEC parity using cross-layer optimization the method being using layer structure with a lower layer, a transport layer operating on the lower layer, and an MPEG media transport (MMT) layer, the method comprising:
deciding the size of an FEC parity data set by using channel state information received from the lower layer.

12. The method of claim 11, wherein the deciding of the size of the FEC parity data set by using the channel state information received from the lower layer includes receiving channel state information by using a cross-layer interface performing data transmission between an application layer and a lower layer including an MAC or PHY layer.

13. The method of claim 11, wherein:
the deciding of the size of the FEC parity data set by using the channel state information received from the lower layer includes
receiving bit error rate (BER) information from the lower layer,
estimating a channel state by using the bit error rate (BER) information, and
deciding the size of the FEC parity data set by using the estimated channel state.

14. The method of claim 11, wherein in the deciding of the size of the FEC parity data set by using the channel state information received from the lower layer, the size of the FEC parity data set included in the channel state information is used as the size of the FEC parity data set.

15. The method of claim 11, further comprising:
generating parity data by using the decided size of the parity data set.

16. The method of claim 15, wherein the generating of the parity data by using the decided size of the parity data set includes generating parity data by including a field indicating the size of the parity data in a header of the parity data.

17. The method of claim 16, wherein the field indicating the size of the parity data indicates the size of the parity data by designating any one of sets of a predetermined size.

18. The method of claim 11, wherein the multimedia transmitting method supports hybrid transmission.

19. An apparatus for transmitting multimedia through adaptively controlling an FEC parity, wherein the size of an FEC parity data set is decided by using channel state information received from a lower layer.
